(19) United States
(12) Patent Application Publication
(10) Pub. No.: US 2026/0193118 A1
(43) Pub. Date: Jul. 9, 2026

(54) METHODS AND SYSTEMS FOR PRODUCING WATER FROM A WASTE STREAM

(71) Applicant: Cambrian Innovation, Inc., Watertown, MA (US)

(72) Inventors: Zhen Huang, Newton, MA (US); Patrick Kelly, Big Bend, WI (US)

(73) Assignee: Cambrian Innovation, Inc., Watertown, MA (US)

(21) Appl. No.: 19/012,219

(22) Filed: Jan. 7, 2025

(51) Int. Cl. C02F 9/00; C02F 1/42; C02F 1/44; C02F 3/06; C02F 3/12; C02F 103/00

(52) U.S. Cl. CPC C02F 9/00; C02F 1/42; C02F 1/441; C02F 1/442; C02F 3/06; C02F 3/121; C02F 2103/003

(57) ABSTRACT

The present disclosure relates to systems and related methods for producing water from a waste stream. Such systems and related methods can include recovering and recycling alkalinity, micronutrients, and/or macronutrients.

### FIELD

The present disclosure relates to systems and related methods for producing water from a waste stream. Such systems and related methods can include recovering and recycling alkalinity, micronutrients, and/or macronutrients.

### BACKGROUND

There exist industrial facilities that produce wastewater that must be treated before any water can be re-used or stored. Treatment of such wastewater can include the use of anaerobic reactors, which can incur high operating costs and/or high consumption of chemicals to maintain such reactors.

### SUMMARY

The present disclosure sets forth non-limiting systems and related methods for treating a waste stream. In some embodiments, such systems and methods can produce water from the treatment of a waste stream. Without wishing to be limited by theory, the systems and methods herein can include recovering alkalinity and/or a nutrient from a processed waste stream and recycling the recovered components. In some embodiments, alkalinity can include one or more carbonate species (e.g., bicarbonate, including salts thereof) and/or one or more hydroxide species (e.g., hydroxide, including salts thereof). In some embodiments, the nutrient can include one or more micronutrients (e.g., one or more metals and/or minerals) and/or one or more macronutrients (e.g., one or more sources of nitrogen or phosphorus). The recovered component can include any combination of one or more alkalinity and/or nutrients.

In one non-limiting aspect, the present disclosure encompasses a system for producing water from a waste stream. In some embodiments, the system includes: a first chamber configured to receive at least one waste stream and to yield a digested waste stream; a second chamber configured to receive the digested waste stream, or a portion thereof, and to decontaminate the digested waste stream to yield a decontaminated waste stream; a separation unit configured to receive the decontaminated waste stream, or a portion thereof, and to yield a concentrated effluent and a permeate; and a recycle line configured to transfer the concentrated effluent, or a portion thereof, from the separation unit to the first chamber and/or to a region upstream of the first chamber.

In some embodiments, the concentrated effluent includes alkalinity (e.g., one or more carbonate species, such as bicarbonate and/or carbonate, including salts thereof; and/or one or more hydroxide species, including salts thereof) and/or a nutrient (e.g., one or more micronutrients and/or macronutrients); and the permeate includes water (e.g., drinkable water). Non-limiting characteristics for water can pH from about 6.5 to about 8.5.

In some embodiments, the first chamber includes an anerobic digestion (AD) chamber. In some embodiments, the first chamber is configured to provide the digested waste stream characterized by a biological oxygen demand (BOD) removal of greater than about 70% as compared to the at least one waste stream.

In some embodiments, the second chamber includes a biological treatment system comprising a suspended growth activated sludge and/or fixed film.

In some embodiments, the second chamber includes a membrane bioreactor, an ultrafiltration reactor, an activated sludge bioreactor, a clarifier, a sequencing batch reactor.

In some embodiments, the second chamber is configured to provide the decontaminated waste stream characterized by biological oxygen demand (BOD) of less than about 10 ppm and/or total suspended solids (TSS) of less than about 1 ppm.

In further embodiments, the system includes a filtration unit disposed between the second chamber and the separation unit. In some embodiments, the filtration unit includes activated carbon, mixed media filtration, coagulant/flocculant addition, and/or ion exchange softening. Optionally, the system can further include, in addition to filtration unit located after second chamber and before separation unit, one or more of the following: pH adjustment, disinfection (e.g., by use of ultraviolet (UV) radiation, chloramine, chlorine, etc.), and/or dechlorination.

In some embodiments, the separation unit is configured to perform reverse osmosis and/or nanofiltration.

In some embodiments, the recycle line is fluidically connected directly or indirectly to the first chamber.

In further embodiments, the system includes a storage chamber upstream of the first chamber. In some embodiments, the recycle line is fluidically connected directly or indirectly to the storage chamber.

In some embodiments, the system is configured to provide a recovery rate of water greater than about 70%.

In further embodiments, the system includes a pump configured to transport the concentrated effluent, or a portion thereof, through the recycle line.

In another aspect, the present disclosure encompasses a method for producing water. In some embodiments, the method includes: digesting at least one waste stream to yield a digested waste stream; decontaminating the digested waste stream, or a portion thereof, to yield a decontaminated waste stream; separating the decontaminated waste stream, or a portion thereof, to yield a concentrated effluent including alkalinity (e.g., one or more carbonate species or hydroxide species, such as bicarbonate, carbonate, hydroxide, or salts thereof) and/or a nutrient (e.g., one or more micronutrients and/or macronutrients) and a permeate including water; and recycling the concentrated effluent, or a portion thereof, by delivery to the at least one waste stream, the digested waste stream, and/or the decontaminated waste stream.

In some embodiments, said digesting includes anaerobic digestion of the at least one waste stream.

In some embodiments, the digested waste stream is characterized by a biological oxygen demand (BOD) removal of greater than about 70% as compared to the at least one waste stream.

In some embodiments, said decontaminating includes nitrification, denitrification, phosphorus reduction or removal, BOD reduction or removal, chemical oxygen demand (COD) reduction or removal, and/or total organic carbon (TOC) reduction or removal from the digested waste stream, or a portion thereof.

In further embodiments, the method includes: filtering the decontaminated waste stream, or a portion thereof, before said separating.

In some embodiments, said separating includes reverse osmosis and/or nanofiltration.

In some embodiments, the concentrated effluent further includes one or more macronutrients (e.g., nitrogen and/or phosphorus) and/or micronutrients (e.g., calcium, magnesium, nickel, cobalt, and/or iron).

In some embodiments, the concentrated effluent is characterized by BOD of less than about 10 ppm and/or total dissolved solids (TDS) of greater than about 1 ppm.

In further embodiments, the method includes: removing or reducing total organic carbon (TOC), adjusting pH, injecting antiscalant, and/or disinfecting before or after said separating.

In some embodiments, said recycling includes delivering the concentrated effluent, or a portion thereof, to the at least one waste stream before said digesting and/or during said digesting.

In some embodiments, the method is characterized by a recovery rate of water that is greater than about 70%.

### BRIEF DESCRIPTION OF THE DRAWINGS

FIG. 1A provides a schematic of a non-limiting system including a first chamber 110, a second chamber 120, and a separation unit 130.

FIG. 1B provides a schematic of another non-limiting system including a first chamber 110, a second chamber 120, a first separation unit 130A, and a second separation unit 130B.

FIG. 2 provides a block diagram of a non-limiting method 200 for producing water from a waste stream.

### DETAILED DESCRIPTION

As used herein, the words “comprising”, and any form thereof such as “comprise” and “comprises”; “having”, and any form thereof such as “have” and “has”; “including”, and any form thereof such as “includes” and “include”; and “containing” and any form thereof such as “contains” and “contain” are inclusive or open-ended and do not exclude additional, unrecited elements or process steps.

As used herein, the term “stream” can include various molecules in liquid or gas state, and can include mixtures of gases, liquids, and particulate solids. Generally, a stream can be a waste stream (e.g., a wastewater stream). As used herein, the term “wastewater” can mean water containing dissolved organics obtained from at least one of agricultural or farm, food processing, petrochemical, beverage, dye, textile, residential or domestic, and pharmaceutical facilities or sources, for example.

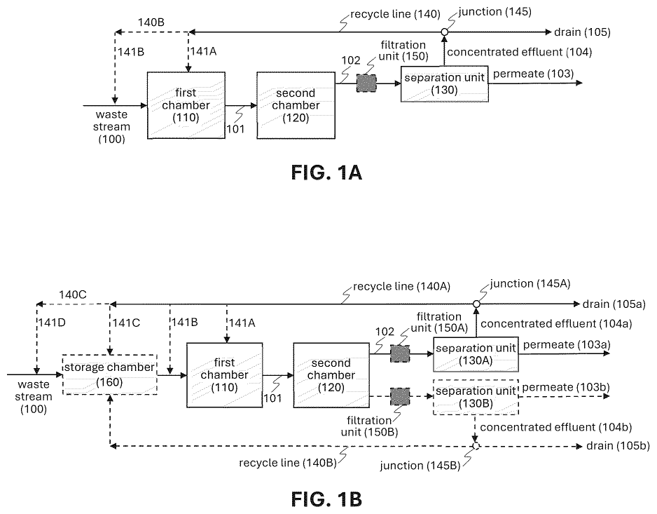

As depicted, process flow lines in FIG. 1A-1B may be referred to as a connection, where a connection may comprise a line, pipe, input, output, feed, or stream, for example.

As used herein, the terms “exemplary” or “embodiment” mean a non-limiting example of the present disclosure.

As used herein, the term “about” or “approximately” is defined as being close to or near as understood by one of ordinary skill in the art, and in some embodiments may be quantified as within 10%, more particularly within 5%, still more particularly within 1%, and is in some cases within 0.5%.

As used herein, the term “a” or “an” when used in conjunction with the term comprising or a form thereof may mean “one” but is also consistent with the meaning of “one or more”, “at least one”, and “one or more than one”.

As used herein, the term “coupled” can mean two items, directly or indirectly, joined, fastened, associated, supported, connected, attached, or formed integrally together either by chemical or mechanical means, by processes including stamping, molding, or welding. What is more, two items can be coupled using a third component such as a mechanical fastener, e.g., a screw, a nail, a staple, or a rivet; an adhesive; or a solder.

As used herein, the term “fluidically connected” refers to any duct, channel, tube, pipe, chamber, or pathway through which a substance, such as a liquid, gas, or solid may pass substantially unrestricted when the pathway is open. When the pathway is closed, the substance is substantially restricted from passing through. Typically, limited diffusion of a substance through the material of a plate, base, and/or a substrate, which may or may not occur depending on the compositions of the substance and materials, does not constitute fluidic communication.

It should be understood at the outset that although an exemplary implementation of at least one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

The present disclosure relates to a system and a method for producing water from a waste stream. As described herein, the use of certain reactors can provide increased operating costs when employed with waste streams having low alkalinity. For example and without limitation, waste streams from industrial effluents tend to have very low alkalinity and low protein content. Processing such waste streams within anaerobic digestion (AD) reactors can result in rapid accumulation of volatile fatty acids (VFA), which in turn can detrimentally affect anaerobic processes within such AD reactors. Without wishing to be limited by mechanism or theory, control of alkalinity can, in turn, promote controlled anaerobic processes. In some non-limiting embodiments, alkalinity can be controlled by using a carbonate species (e.g., bicarbonate and/or carbonate, as well as salts thereof) to buffer the contents within the AD reactor. Yet, exogenous addition of bicarbonate can contribute to high operating costs. Accordingly, described herein are systems and methods to recover alkalinity from a digested waste stream (e.g., a waste stream processed within an AD reactor) and then to recycle such recovered alkalinity (e.g., within the AD reactor). In one non-limiting example, the system or the method can include a separation unit configured to receive a digested waste stream and to yield a concentrated effluent (e.g., including a carbonate species, such as bicarbonate and/or carbonate) and a permeate (e.g., including water). In some embodiments, the concentrated effluent is recycled to the AD reactor.

AD reactors may benefit, in some non-limiting instances, from the presence of certain nutrients that are useful to maintain microorganisms within the reactor. For example and without limitation, micronutrients include calcium, magnesium, nickel, cobalt, and/or iron. In another non-limiting example, useful macronutrients include sources of nitrogen and/or phosphorus in any useful form, such as a protonated form (e.g., ammonia), an oxide form (e.g., phosphate), a salt form, and/or a mineral (e.g., struvite). Exogenous addition of such nutrients can be costly. Accordingly, described herein are systems and methods to recover nutrients from a digested waste stream (e.g., a waste stream processed within an AD reactor) and then to recycle such recovered nutrients (e.g., within the AD reactor). In one non-limiting example, the system or the method can include a separation unit configured to receive a digested waste stream and to yield a concentrated effluent (e.g., including one or more nutrients, such as one or more micronutrients and/or macronutrients) and a permeate (e.g., including water). In some embodiments, the concentrated effluent is recycled to the AD reactor.

In certain non-limiting instances, both alkalinity and nutrients are recovered and recycled within any system or method described herein.

Referring to FIG. 1A, an exemplary system includes a first chamber 110 configured to receive a waste stream 100 and to yield a digested waste stream 101; and a second chamber 120 configured to receive the digested waste stream 101 and to decontaminate the digested waste stream 101 to yield a decontaminated waste stream 102.

In some embodiments, the first chamber is an anaerobic digestion (AD) chamber. In some embodiments, the first chamber is configured to provide the digested waste stream characterized by a biological oxygen demand (BOD) removal of greater than about 70% as compared to the at least one waste stream (e.g., from about 70% to about 99%, about 70% to about 98%, about 70% to about 97%, about 70% to about 96%, about 70% to about 95%, about 70% to about 94%, about 70% to about 93%, about 70% to about 92%, about 70% to about 91%, or about 70% to about 90%); and/or an alkalinity of greater than about 100 ppm as calcium carbonate (CaCO₃) (e.g., from about 100 ppm to about 50000 ppm, about 100 ppm to about 10000 ppm, about 1000 ppm to about 8000 ppm, about 1000 ppm to about 7000 ppm, about 1000 ppm to about 6000 ppm, or about 1000 ppm to about 5000 ppm). In some embodiments, BOD can refer to the measure of the amount of oxygen needed by one or more microorganisms to break down organic (e.g., carbonaceous) material under aerobic conditions.

In some embodiments, the second chamber is or includes a biological treatment system comprising a suspended growth activated sludge and/or fixed film, including but not limited to a membrane bioreactor (MBR). In some embodiments, the second chamber is or includes an MBR, a moving bed biofilm reactor (MBBR), an integrated fixed film activated sludge (IFAS) reactor, an ultrafiltration reactor, an activated sludge bioreactor, a clarifier, or a sequencing batch reactor. In some embodiments, the MBR is a Cambrian BlueCycle™ MBR. The MBR may comprise a combined aerobic digester coupled to a membrane filtration element that is configured to convert organic residue within the digested waste stream. In some non-limiting embodiments, the second chamber is configured to provide heterotrophic BOD oxidation and suspended solids separation. In other non-limiting embodiments, the second chamber is configured to provide heterotrophic denitrification, biological phosphorus removal, and/or chemical phosphorus removal. In some embodiments, the second chamber is configured to provide the decontaminated waste stream characterized by ammonia and/or ammonium of less than about 1 ppm; nitrate of less than about 100 ppm; nitrite of less than about 1 ppm; phosphorus of less than about 100 ppm; BOD of less than about 10 ppm; chemical oxygen demand (COD) of less than about 10 ppm; alkalinity of less than about 3000 ppm as CaCO₃ (e.g., from about 500 ppm to 3000 ppm, about 1000 ppm to 3000 ppm, or about 1500 ppm to 3000 ppm); and/or total suspended solids (TSS) of less than about 1 ppm. In some embodiments, COD can refer to the measure of the amount of oxygen needed to chemically oxidize material in wastewater. In some embodiments, COD may not include oxidation of ammonia to nitrates and/or nitrites.

Referring again to FIG. 1A, an exemplary system includes a separation unit 130 configured to receive the decontaminated waste stream 102 and to yield a concentrated effluent 104. In some embodiments, the concentrated effluent includes alkalinity (e.g., a carbonate species, such as bicarbonate and/or carbonate, as well as salts thereof) and/or a nutrient (e.g., one or more micronutrients and/or macronutrients); and the permeate includes water. In some embodiments, the separation unit can be configured to perform reverse osmosis and/or nanofiltration. Any useful confirmation can be used in the separation unit. For example and without limitation, reverse osmosis and/or nanofiltration configurations can include any useful stage configuration (e.g., single stage or multistage), pass configuration (e.g., single pass or multiple passes), and/or recycle configuration (e.g., internal concentrate recycle).

An exemplary system can also include a recycle line 140 configured to transfer the concentrated effluent 104, or a portion thereof, from the separation unit 130 to the first chamber 110. A recycle line can be fluidically connected directly or indirectly to the first chamber 110. For instance, connections can be formed between the recycle line 140 and the first chamber 110 (via line 141A) and/or between an optional extended portion 140B of the recycle line 140 and a region upstream of the first chamber 110 (via line 141B). In this way, alkalinity isolated from the decontaminated waste stream 102 and present within the concentrated effluent 104 can be recycled to a component upstream of the separation unit (e.g., the first chamber 110 that is upstream of the separation unit 130). Excess concentrated effluent can be stored (e.g., in a storage container, not shown in FIG. 1A) and/or drained 105. A junction 145 can be present between the recycle line 140 and the line to the drain 105. The junction can be configured to provide for discharge of excess concentrated effluent in any useful manner, e.g., discharge in a batch manner or in a continuous manner to reduce accumulation of salts in the system and/or to reduce overload of any units within the system (e.g., separation unit 130 and/or first chamber 110). In some embodiments, the junction can include a valve, a storage container, etc.

Alkalinity can have any useful form. For example and without limitation, alkalinity can include a carbonate species (e.g., a bicarbonate ion or a carbonate ion), a hydroxide species (e.g., a hydroxide ion), or a combination of any of these. For any compound described herein (e.g., such as a carbonate species and/or a hydroxide species), salt forms may be provided. Non-limiting salts can include one or more alkali metal salts (e.g., lithium, sodium, potassium, and the like), alkaline earth metal salts (e.g., magnesium, calcium, and the like), others (e.g., transition metal salts), as well as combinations of two or more salts.

The concentrated effluent may include other compounds, as well as alkalinity. In some embodiments, the concentrated effluent includes one or more macronutrients (e.g., nitrogen and/or phosphorus) and/or micronutrients (e.g., calcium, magnesium, nickel, cobalt, and/or iron).

The separation unit 130 can also be configured to yield a permeate 103. In some embodiments, the permeate can be a purified water stream (e.g., water that satisfies at least California's Title 22 water standards, for example), which may optionally be re-used by system or stored in storage tanks (not shown in FIG. 1A). In some embodiments, the permeate is characterized by alkalinity of less than about 100 ppm as calcium carbonate (CaCO₃) (e.g., less than about 90 ppm, 80 ppm, 70 ppm, 60 ppm, 50 ppm, 40 ppm, 30 ppm, 20 ppm, 10 ppm, 5 ppm, or less, as CaCO₃). In some embodiments, the system can be configured to provide a recovery rate of water greater than about 70%.

Optionally, the system can include a filtration unit. Referring to FIG. 1A, the system can include a filtration unit 150 disposed between the second chamber 120 and the separation unit 130. The filtration unit can include activated carbon, mixed media filtration, coagulant/flocculant addition, and/or ion exchange softening. Optionally, the system can further include, in addition to filtration unit located after second chamber and before separation unit, one or more of the following: pH adjustment, disinfection (e.g., by use of ultraviolet (UV) radiation, chloramine, chlorine, etc.), and/or dechlorination.

The systems herein can include one or more first chambers, second chambers, separation units, filtration units, and/or other chambers. In one non-limiting example, any of the first chambers (e.g., first chambers 110 in FIG. 1A-B) can be provided as a plurality of first chambers connected in parallel. In another non-limiting example, any of the second chambers (e.g., second chambers 120 in FIG. 1A-B) can be provided as a plurality of second chambers connected in parallel. Any useful number (e.g., one, two, three, four, five or more) and any useful configuration (e.g., parallel or serial) of chambers (e.g., first and/or second chamber(s)) may be present in the systems herein. Non-limiting examples of components for systems are described in U.S. Pat. Nos. 9,771,288, 9,963,790, 10,851,003, and 11,708,284, each of which is incorporated herein by reference in its entirety.

Referring to FIG. 1B, another exemplary system includes a first chamber 110 configured to receive a waste stream 100 and to yield a digested waste stream 101; an optional storage chamber 160 upstream of the first chamber 110; and a second chamber 120 configured to receive the digested waste stream 101 and to decontaminate the digested waste stream 101 to yield a decontaminated waste stream 102.

One or more separation units can be present. Referring again to FIG. 1B, the system can include a first separation unit 130A configured to receive a first portion of the decontaminated waste stream 102 and to yield a first concentrated effluent 104a and a first permeate 103a; as well as a second separation unit 130B configured to receive a second portion of the decontaminated waste stream 102 and to yield a second concentrated effluent 104b and a second permeate 103b. The concentrated effluent 104a/104b can include alkalinity and/or a nutrient. When a plurality of separation units are present, each separation unit can be fluidically connected to a single recycle line or a plurality of recycle lines.

Referring again to FIG. 1B, the exemplary system can also include a first recycle line 140A configured to transfer the first concentrated effluent 104a, or a portion thereof, from the first separation unit 130A to the storage chamber 160, the first chamber 110, and/or a region of the system that is upstream of the first chamber 110. The first recycle line can be fluidically connected directly or indirectly to any component in the system. For instance, connections can be formed between the first recycle line 140A and the first chamber 110 (via line 141A), between the first recycle line 140A and a region upstream of the first chamber 110 (via line 141B), between the first recycle line 140A and the optional storage chamber 160 (via line 141C), and/or between an optional extended portion 140C of the recycle line 140A and a region upstream of the first chamber 110 (via line 141D). In this way, alkalinity and/or a nutrient isolated from the decontaminated waste stream 102 and present within the first concentrated effluent 104a can be recycled to a component upstream of the separation unit (e.g., the first chamber 110 that is upstream of the first separation unit 130A and/or the storage chamber 160 that is upstream of the first separation unit 130A). Excess concentrated effluent can be stored (e.g., in a storage container, not shown in FIG. 1A) and/or drained 105a/105b. A junction 145A/145B can be present between the recycle line 140A/140B and the line to the drain 105a/105b. The junction can be configured to provide for discharge of excess concentrated effluent in any useful manner, e.g., discharge in a batch manner or in a continuous manner to reduce accumulation of salts in the system and/or to reduce overload of any units within the system (e.g., separation unit 130A/130B and/or first chamber 110). In some embodiments, the junction can include a valve, a storage container, etc. The system can optionally include a first filtration unit 150A disposed between the second chamber 102 and the first separation unit 130A.

The system can include one or more recycle lines. Referring again to FIG. 1B, the exemplary system can also include a second recycle line 140B configured to transfer the second concentrated effluent 104b, or a portion thereof, from the second separation unit 130B to the storage chamber 160 and/or the first chamber 110. The second recycle line 104B can be fluidically connected directly or indirectly to any component in the system (e.g., similar to the first recycle line 140A). In this way, alkalinity and/or a nutrient present within the second concentrated effluent 104b can be recycled to a component upstream of the separation unit (e.g., the first chamber 110 that is upstream of the second separation unit 130B, the storage chamber 160 that is upstream of the second separation unit 130B, and/or a region upstream of the first chamber 110,). The system can optionally include a second filtration unit 150B disposed between the second chamber 102 and the second separation unit 130B.

The systems herein can include one or more further reactors, chambers, filter units, and the like. In some embodiments, the system can include a storage chamber upstream of the first chamber. In some embodiments, the system can include one or more heaters, exchangers, pipes, pumps (e.g., one or more pumps configured to transport the concentrated effluent, or a portion thereof, through the recycle line), compressors, pipes, controllers, and combinations of any of these. Additionally, an equipment item, such as a reactor, dryer, or vessel, can further include one or more zones or sub-zones.

The system may be controlled by a controller subsystem by exchanging electrical control signals and measured data with one or more elements (e.g., sensors, valves—not shown) of each component (e.g., first chamber(s), second chamber(s), line(s), recycle line(s), filtration unit(s), and/or separation unit(s) in FIG. 1A-1B) via dedicated or shared communication link(s). In some embodiments, the controller subsystem may be configured with at least one electronic processor and memory that stores electrical instructions (e.g., firmware, software), which when triggered by measured data or a fixed or variable threshold(s) may cause the processor to execute the stored instructions to analyze, determine and/or modify the operating parameters for one or more components (e.g., first chamber(s), second chamber(s), line(s), recycle line(s), filtration unit(s), and/or separation unit(s) in FIG. 1A-1B), thereby controlling the process of producing water, among other processes. In addition, the controller subsystem may be operable to control the initial input of the waste stream into the system, as well as the output of water, treated waste streams, and/or gases by exchanging electrical control signals and measured data with one or more elements (e.g., sensors, valves—not shown) of each component (e.g., first chamber(s), second chamber(s), line(s), recycle line(s), filtration unit(s), and/or separation unit(s) in FIG. 1A-1B) via dedicated or shared communication links, for example.

Still further, the controller subsystem may be configured to execute stored instructions to control one or more components (e.g., first chamber(s), second chamber(s), line(s), recycle line(s), filtration unit(s), and/or separation unit(s) in FIG. 1A-1B) by similarly exchanging electrical control signals and/or measured data via dedicated or shared communication links, for example.

In embodiments, the measured data may comprise pH, pressures, alkalinity, temperatures, flow rates while exemplary analysis may comprise executable instructions for determining compositional analysis, determining volatile fatty acids (VFAs), biological oxygen demands (BOD), chemical oxygen demands (COD), ammonia, ammonium, nitrite, nitrate, phosphorus, total suspended solids (TSS), total dissolved solids (TDS), total organic carbon (TOC), and the like. The controller subsystem may be configured to execute stored instructions to determine the amount of biogas produced (e.g., amount of methane produced) which, optionally, can be transmitted from the controller subsystem and used for accounting purposes, for example. Moreover, the controller subsystem may additionally execute stored instructions to determine the efficiency of one or more elements of the system by, for example, measuring the amount or absence of alkalinity (e.g., as determined by the amount of calcium carbonate).

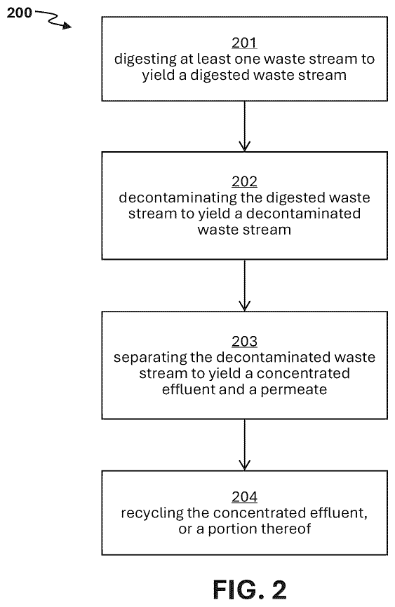

As seen in FIG. 2, the present disclosure encompasses methods for producing water. A non-limiting method 200 can include digesting 201 at least one waste stream to yield a digested waste stream; decontaminating 202 the digested waste stream, or a portion thereof, to yield a decontaminated waste stream; separating 203 the decontaminated waste stream, or a portion thereof, to yield a concentrated effluent (e.g., comprising alkalinity and/or a nutrient) and a permeate comprising water; and recycling 204 the concentrated effluent, or a portion thereof, by delivery to the at least one waste stream, the digested waste stream, and/or the decontaminated waste stream. In some embodiments, the method can employ any system described herein.

In some embodiments, digesting includes anaerobic digestion of the at least one waste stream. The digested waste stream can be characterized by a BOD removal of greater than about 70% as compared to the at least one waste stream.

Decontaminating can include any useful process. In some embodiments, decontaminating can include nitrification, denitrification, phosphorus reduction, BOD removal or reduction, COD removal or reduction, and/or TOC removal or reduction from the digested waste stream, or a portion thereof.

Recycling can include delivering the concentrated effluent, or a portion thereof, to the at least one waste stream before said digesting and/or during said digesting.

The methods herein can include other processes. In some embodiments, the method can further include: filtering the decontaminated waste stream, or a portion thereof, before said separating. In other embodiments, the method can further include: removing TOC, adjusting pH, injecting antiscalant, and/or disinfecting before or after said separating.

In some embodiments, the concentrated effluent is characterized by a concentration of alkalinity (e.g., a carbonate species, such as bicarbonate, carbonate, hydroxide, or salts thereof) from about 100 ppm to about 50000 ppm (e.g., from about 100 ppm to about 10000 ppm, about 1000 ppm to about 10000 ppm, about 1000 ppm to 8000 ppm, or about 1000 ppm to 7000 ppm). In other embodiments, the concentrated effluent includes one or more macronutrients (e.g., nitrogen and/or phosphorus) and/or micronutrients (e.g., calcium, magnesium, nickel, cobalt, and/or iron). In yet other embodiments, the concentrated effluent is characterized by BOD of less than about 10 ppm and/or TDS of greater than about 1 ppm.

In some embodiments, the permeate can be a purified water stream (e.g., water that satisfies at least California's Title 22 water standards, for example). In other embodiments, the method can be characterized by a recovery rate of water greater than about 70%.

The systems and methods herein can produce water or water products from a waste stream. In some embodiments, the water product complies with at least California's Title 22 water standards, for example.

### Other Embodiments

All publications, patents, and patent applications mentioned in this specification are incorporated herein by reference to the same extent as if each independent publication or patent application was specifically and individually indicated to be incorporated by reference.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

Other embodiments are within the claims.

1. A system for producing water from a waste stream, the system comprising:
a first chamber configured to receive at least one waste stream and to yield a digested waste stream;
a second chamber configured to receive the digested waste stream, or a portion thereof, and to decontaminate the digested waste stream to yield a decontaminated waste stream;
a separation unit configured to receive the decontaminated waste stream, or a portion thereof, and to yield (i) a concentrated effluent comprising alkalinity and/or a nutrient and (ii) a permeate comprising water; and
a recycle line configured to transfer the concentrated effluent, or a portion thereof, from the separation unit to the first chamber and/or a region upstream of the first chamber.

2. The system of claim 1, wherein the first chamber comprises an anerobic digestion (AD) chamber.

3. The system of claim 2, wherein the first chamber is configured to provide the digested waste stream characterized by a biological oxygen demand (BOD) removal of greater than about 70% as compared to the at least one waste stream.

4. The system of claim 1, wherein the second chamber comprises a biological treatment system comprising a suspended growth activated sludge and/or fixed film, a membrane bioreactor, a moving bed biofilm reactor, an integrated fixed film activated sludge reactor an ultrafiltration reactor, an activated sludge bioreactor, a clarifier, or a sequencing batch reactor.

5. The system of claim 4, wherein the second chamber is configured to provide heterotrophic BOD oxidation, suspended solids separation, heterotrophic denitrification, biological phosphorus removal, and/or chemical phosphorus removal.

6. The system of claim 4, further comprising a filtration unit disposed between the second chamber and the separation unit.

7. The system of claim 6, wherein the filtration unit comprises activated carbon, mixed media filtration, coagulant/flocculant addition, and/or ion exchange softening.

8. The system of claim 1, wherein the separation unit is configured to perform reverse osmosis and/or nanofiltration.

9. The system of claim 1, wherein the recycle line is fluidically connected directly or indirectly to the first chamber.

10. The system of claim 1, further comprising a storage chamber upstream of the first chamber.

11. The system of claim 10, wherein the recycle line is fluidically connected directly or indirectly to the storage chamber.

12. The system of claim 1 wherein the system is configured to provide a recovery rate of water greater than about 70%.

13. The system of claim 1 further comprising a pump configured to transport the concentrated effluent, or a portion thereof, through the recycle line.

14. A method for producing water, the method comprising:
digesting at least one waste stream to yield a digested waste stream;
decontaminating the digested waste stream, or a portion thereof, to yield a decontaminated waste stream;
separating the decontaminated waste stream, or a portion thereof, to yield (i) a concentrated effluent comprising alkalinity and/or a nutrient and (ii) a permeate comprising water; and
recycling the concentrated effluent, or a portion thereof, by delivery to the at least one waste stream, the digested waste stream, and/or the decontaminated waste stream.

15. The method of claim 14, wherein said digesting comprises anaerobic digestion of the at least one waste stream.

16. The method of claim 14, wherein the digested waste stream is characterized by a biological oxygen demand (BOD) removal of greater than about 70% as compared to the at least one waste stream.

17. The method of claim 14, wherein said decontaminating comprises nitrification, denitrification, phosphorus reduction, biological oxygen demand (BOD) reduction, chemical oxygen demand (COD) reduction, and/or total organic carbon (TOC) reduction from the digested waste stream, or a portion thereof.

18. The method of claim 14, further comprising:
filtering the decontaminated waste stream, or a portion thereof, before said separating.

19. The method of claim 14, said separating comprises reverse osmosis and/or nanofiltration.

20. The method of claim 14, wherein the concentrated effluent further comprises one or more carbonate species; one or more hydroxide species; one or more macronutrients; and/or one or more micronutrients.

21. The method of claim 14, wherein the concentrated effluent is characterized by biological oxygen demand (BOD) of less than about 10 ppm and/or total dissolved solids (TDS) of greater than about 1 ppm.

22. The method of claim 14, wherein the permeate is characterized by alkalinity of less than about 100 ppm as calcium carbonate.

23. The method of claim 14, further comprising:
removing total organic carbon (TOC), adjusting pH, injecting antiscalant, and/or disinfecting before or after said separating.

24. The method of claim 14, wherein said recycling comprises delivering the concentrated effluent, or a portion thereof, to the at least one waste stream before said digesting and/or during said digesting.

25. The method of claim 14 wherein a recovery rate of water is greater than about 70%.
